(19) United States
(12) Patent Application Publication
(10) Pub. No.: US 2008/0086346 A1
(43) Pub. Date: Apr. 10, 2008

(54) ONLINE AUCTION PROFITABILITY ASSESSOR

(76) Inventor: Corey F. Kossack, Tucson, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/861,209

(22) Filed: Sep. 25, 2007

Related U.S. Application Data
(60) Provisional application No. 60/828,524, filed on Oct. 6, 2006.

(51) Int. Cl. G06Q 10/00; G06F 17/00

(52) U.S. Cl. 705/7

(57) ABSTRACT

Online auction sellers use an interactive software tool to analyze the risk of listing certain items for sale in an online auction, where the software tool allows the user to use different listing strategies and pricing. The interactive software tool calculates costs of doing business on auction sites, including fees related to listing items, transaction fees and merchant account fees for credit card processing. In addition, the interactive software tool automatically calculates the net profit margin a seller would achieve during a predetermined number of attempts to sell their item at online auction.

### CROSS REFERENCE

This application claims priority U.S. Provisional Application Ser. No. 60/828,524, filed on Oct. 6, 2006, titled “Online Auction Profitability Assessor”, by Corey F. Kossack, which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### TECHNICAL FIELD

The present invention relates generally to the online auctions, and more specifically to software tools to enhance profitability in the sales and marketing of items for sale via online auctions.

### BACKGROUND

An auction is the process of buying and selling things by offering them up for bid, taking bids, and then selling the item to the highest bidder. As such, the auction determines the value of an item that has an undetermined or variable price. Auctions can be with reserve or minimum, or without minimums, or absolute or no reserve. In reserve auctions, there is a minimum bid or reserve price; if the bidding does not reach the minimum, there is no sale (but the person who puts the item up for auction may still owe a fee to the auctioneer or auction company). In absolute or no reserve auctions, the sale is guaranteed once a bid is placed, with only the price left to be determined. In the context of auctions, a bid is an offered price. Almost anything can be sold at auction.

With the advert of the World Wide Web, online auctions have become increasingly used. An online auction is a virtual auction on the Internet, typically through the World Wide Web. The online auction business model is one in which participants bid for products and services over the internet. As in traditional auctions, a seller sells a product to a person who offers the highest price. For sellers, online auctions open up new sales channels for new products and offer buyers favorable purchasing conditions.

eBay Inc. is a successful online auction website, at which people from all around the world buy and sell goods and services. Millions of collectibles, appliances, computers, furniture, equipment, vehicles, and other miscellaneous items are listed, bought, and sold daily. An example of a Web page 100 from the Website offered by eBay Inc. is seen in FIG. 1. On Web page 100, a seller 108 offers pictured item for sale. Reference numeral 102 shows the starting price at which the seller will allow an auction bidder to place a bid and reference numeral 104 shows a price at which a bidder can purchase the item immediately and without having to bid against other bidders. Reference numeral 106 shows a price that seller 108 charges to the successful bidder to ship the item for receipt by the successful bidder.

Other than the shipping price 106 and the auction purchase price, seller 108 receives no further revenue from the sale of the item. Rather, seller 108 incurs costs and fees for listing each item for sale at the online auction. Online sellers can have many items for sale at an online auction, each of which has costs and fees associated with it being marketed and sold through the online auction Website.

Various tools are known to help a seller to market and sell items at an online auction. Some tools help the seller to create a listing for an item to be sold at the online auction. Such a tool might help create an attractive picture of the item being offered for sale. Other functions can include creating fixed price listings for items, previewing listings before they are submitted to the auction, scheduling when a listing will be submitted, providing a listing description editor, managing inventory automatically, restocking alerts, providing the ability to create listings linked to a specific product, tracking sales information, providing status icons to help track a seller's sales, tools to preview/edit/reschedule/cancel scheduled listings online, tools to monitor a seller's active listings real time, a summary report of the number of pending, active and sold listings that the seller has, a tool to track a seller's gross merchandise volume amount for active and sold listings, etc.

Tools are also available to help a seller after an item has been has sold. These tools provide various functions, including helping the seller to find when the seller's listings' end real time and to track the seller's unsold items, a tool to bulk re-list the seller's sold and unsold items, a tool for the seller to keep track of the seller's buyer communication and whether the seller's items have been paid or shipped in bulk, etc.

Relative to payments to be received by the seller, tools are also known. These tools include a function to provide automatic payment received notification email and automatic item shipped notification email, and automatic feedback left when a buyer pays for a item sold at the online auction site. Another tool can provide a profit and loss report that includes all sales, fees, cost of goods, tax, etc. Simply having such a report, however, will not help the seller to predict or assess in advance the profitability of listing a particular item that the seller may want to sell. It is important that the seller properly manage the seller's unsold listings and to be aware of the success of the seller's listings at all times. After analyzing the impact of unsold listings and feature fees as to the seller's overall profitability, the seller may decide certain items are not profitable or not profitable enough. Such an analysis is complicated and time consuming, though it is important to letting a seller know which items being offered for sale are being done so profitably in view of the fees and cost of goods that the seller must incur incident to selling at the online auction. Accordingly, it would be an advance in the art to provide an interactive tool to analyze profitability of an online auction business of a seller, where such a tool would perform calculations automatically based on listing options specified by the seller and thereby help the seller to analyze the risk of listing a particular item at a particular price for an online auction.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is an exemplary user interface screen for an online auction to be used by a bidder offered for sale by a seller;

FIGS. 2-4 show exemplary tabular costs and fees associated with offering one or more items for sale at an online auction Website

FIG. 5 illustrates an exemplary process for analyzing profitability of an online auction business of a seller; and

FIG. 6 is an exemplary interactive user interface screen offering tools and functionality to analyze the profitability of an item offered for sale by a seller at an online auction.

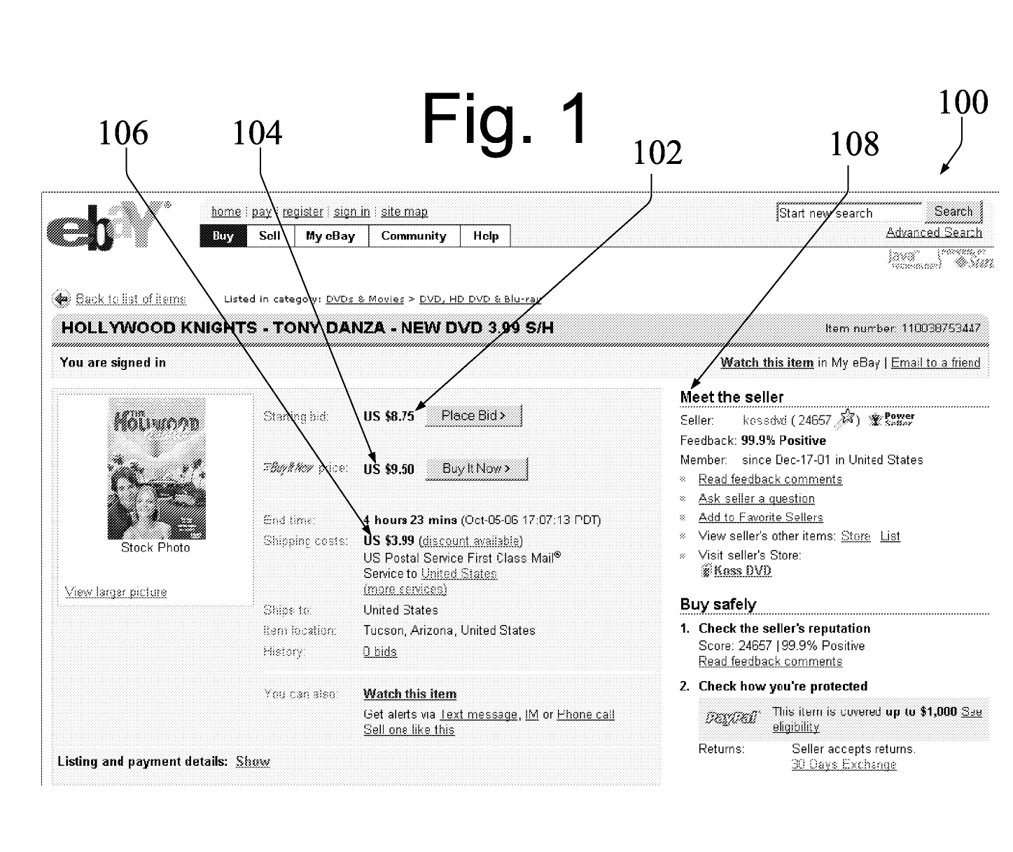

### SUMMARY

Implementations of an interactive software tool helps auction sellers analyze the risk of listing certain items for sale using different listing strategies and pricing. The interactive software tool calculates costs of doing business on auction sites, including fees related to listing items, transaction fees and merchant account fees for credit card processing. In addition, the interactive software tool automatically calculates the net profit margin a seller would achieve during a predetermined number of attempts to sell their item at online auction.

### DESCRIPTION

Various implementations of an interactive software tool are described and illustrated. This tool assists a seller of items in an online auction. One function that the tool provides to the seller is assistance in selecting products and their prices during the product acquisition phase. A seller may have access to warehouses of products that one or more suppliers offer. The seller, however, does not know how profitable each of these items will be if sold at an online auction. The tool will preferably give the seller an understanding of what their profit margins will be on the item if it sells right away and how much risk of loss the seller is assuming in the event that the item has to be listed a number of times before it finally sells. The tool gives users all of this information up front, so the seller can make an informed decision during product selection and continue to operate a profitable business.

Implementations of the tool also can help the seller to examine items that a seller are currently selling to identify ways to increase profits. The tool shows the seller how much money is being lost if the item does not sell right away. This information can help a seller to determine the best course of action. Having this information provided by the tool, the seller may decide that the profit margin that the seller is currently achieving is satisfactory and not make a change to the listing. Alternatively, information provided by the tool may help the seller to decide to lower the item's price to achieve a better conversion rate (e.g.; a higher chance of being sold in less time or a lesser number of times being listed for sale) and a stronger profit. The seller may also use the tools information to reach a decision that the item's feature fees, as discussed below, is lowering the margin too much, and that the item should not be listed at all.

According, implementations of the interactive tool provide a variety of functions that permit a seller to accumulate information that assists the seller in making decisions. These decisions can save the seller a significant amount in lost fees that would have been paid to an online auctioneer, while increasing the seller's conversion rates. Since sellers will have a detailed understanding of their risk of listing each item and the profit that can result if sold at various points in time, they will be able to make informed decisions regarding product selection and pricing. As such, implementations of the interactive tool provide Sellers to the means to learn to sell products that provide the greatest profit potential at the lowest risk level.

One area of expense that a seller does well to account for in online auction sales is an insertion fee. An insertion Fee is a listing fee. It is the price that the auctioneer charges for listing the seller's item for sale. This fee may be charged to the seller at the time of listing and may be required to be paid even if the seller's item is not sold, and may not be refundable. Other fees that may charged. For instance, a reserve fee may be charged if the seller can refuse to accept bids below a certain dollar amount. Another fee may be charged for allowing the seller to sell an item for a predetermined amount rather than allowing the item to be placed into a bidding auction. Yet another fee may be charged for scheduled listings of the seller's items that are for sales on the online action Website. Still another fee may be charged to the seller for presenting the item for sale with a format enhancement, such as bold letter, subtitles, and highlights. Online auctions also typically charge the seller a final value fee. The seller is charged this fee if the seller's item, is sold, ends with a winning bid, or is purchased. This fee may be applied whether or not the seller completes the sale with the buyer.

Given the foregoing fees charged by the online auctioneer to the seller, the seller can use the interactive tool to assess profitability. To do so, the seller can specify variables that are applicable to an item that is being considered for a listing at an online auction site. For instance, the seller can specify:
1. a listing format (auction, fixed, store inventory);
2. quantity of items (dutch auctions, multiple fixed price, multiple auctions of same product);
3. starting bid, reserve and buy it now for auctions;
4. expected sales price for auctions;
5. cost of goods purchased from supplier;
6. cost of postage;
7. cost of packaging materials;
8. list price for fixed and store inventory;
9. listing features (gallery, scheduled listings, etc.); and
10. payment methods

As mentioned above, the seller can specify a listing format in which the seller wishes to sell multiple items in an online action:
1. Online auction-type listing, where the seller lists identical multiple items together in an online auction. The winning bid in a multiple item listing is based on the highest bid per item.
2. fixed listing, where the seller lists multiple, identical items in one listing with a fixed price for each item, and where the buyers can choose the quantity they want and pay the set price.
3. a lot listing, where the seller sells similar items together in one listing to one buyer (a case of shaving razors, a record collection, etc.).

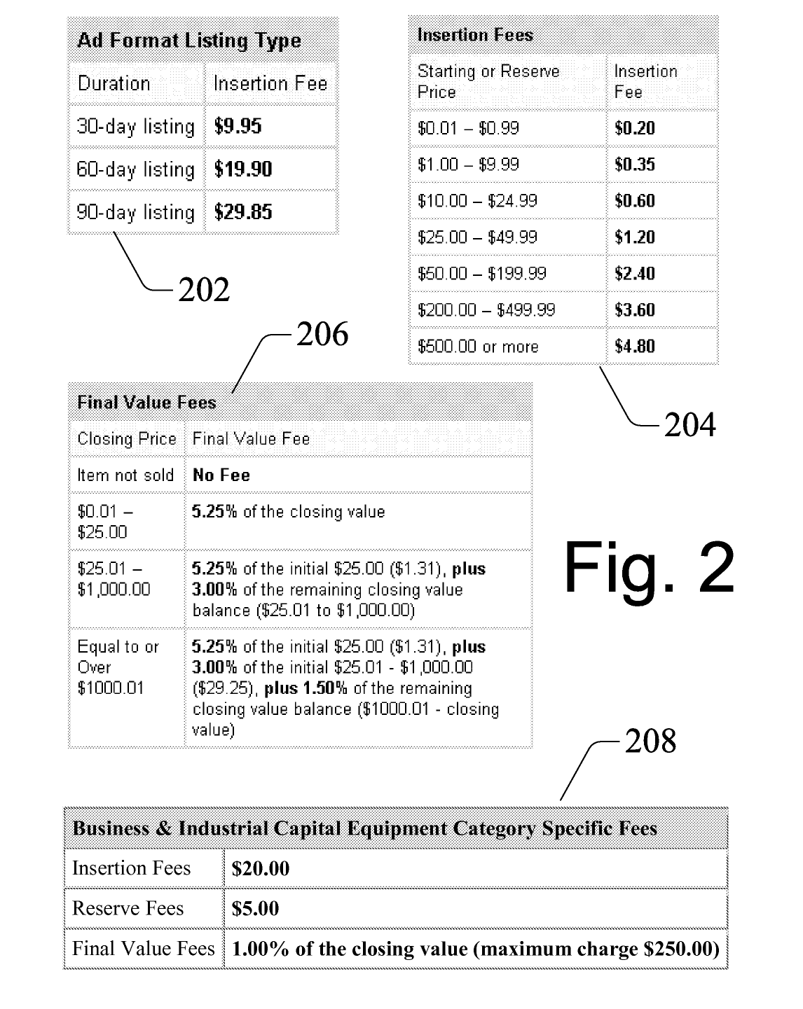

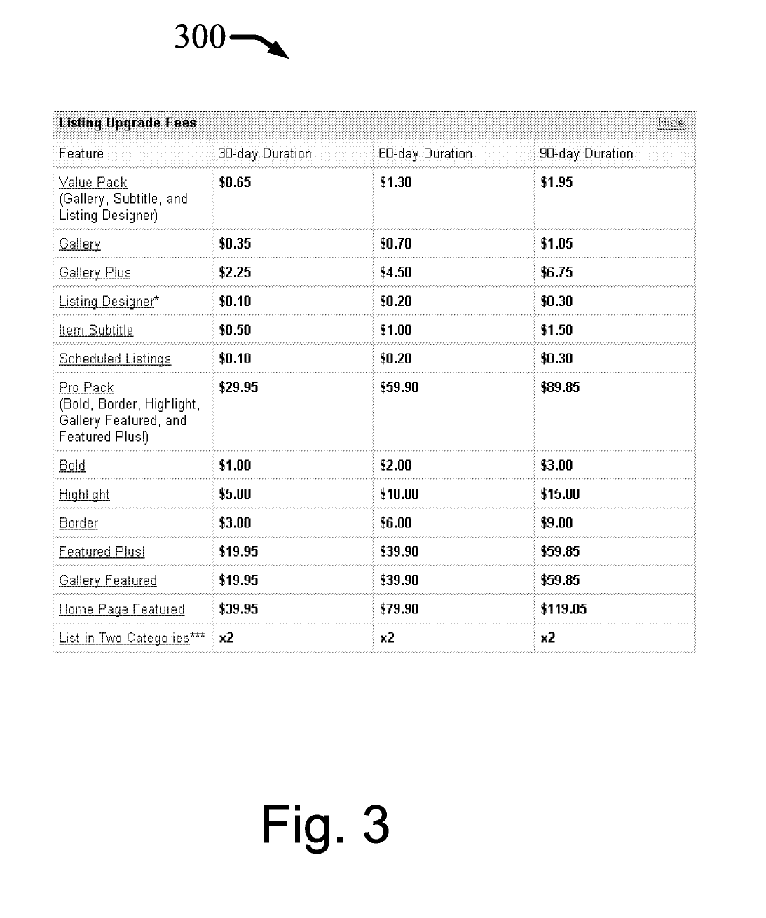

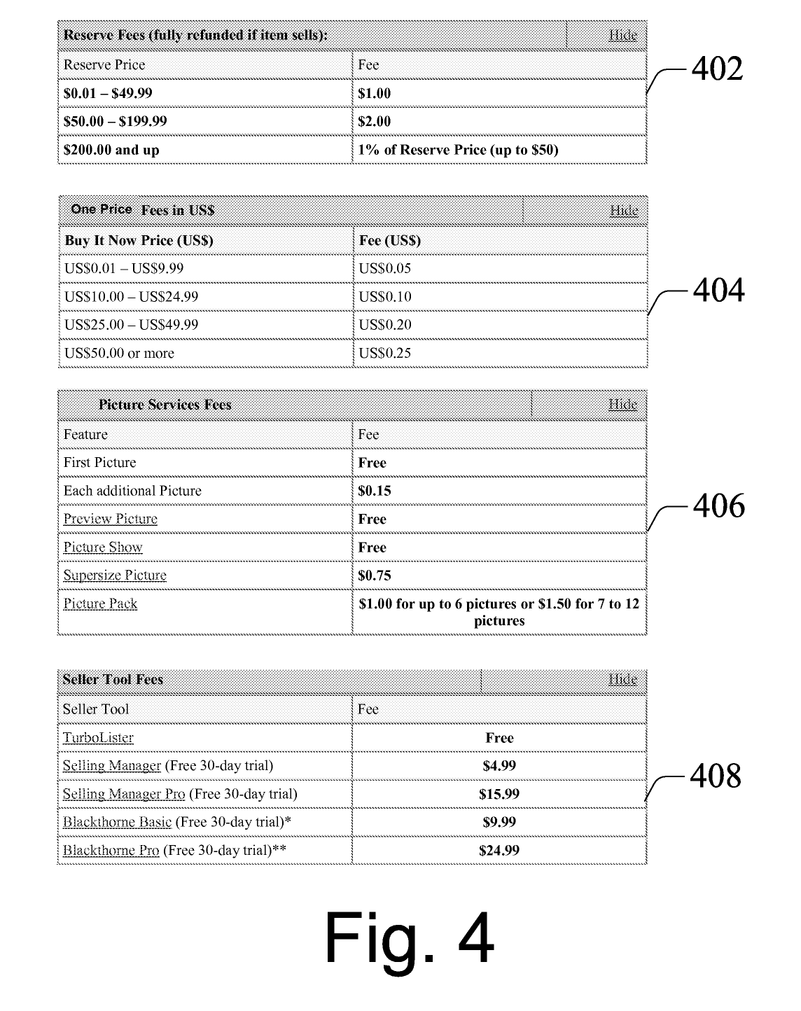

Referring now to FIGS. 2-4, various fees assessed by an online auctioneer to a seller are show in tabular form. FIG. 2. shows rate cards, respectively, for ad format listing types 202, insertion fees 204, final value fees 206, and “Business & Industrial Capital Equipment Category Specific Fees” 208. FIG. 3 shows a rate card for listing upgrade fee 300. FIG. 4 shows rate cards, respectively, for reserve fees 402, one price fees 404, picture service fees 406, and seller tool fees 408.

Based on input by the seller, the interactive tool calculate the following automatically:
1. fees charged by the online auctioneer:
   a. insertion fees;
   b. feature fees; and
   c. final value fees;
2. fees charged by the payer (e.g.; Paypal);
3. fee charged for use of debit or credit cards;
4. risk Ratio;
5. risk Level;
6. margin for the first predetermined number of attempts (e.g.; 10) to sell the item; and
7. the effect of unsold listings on the seller's profitability.

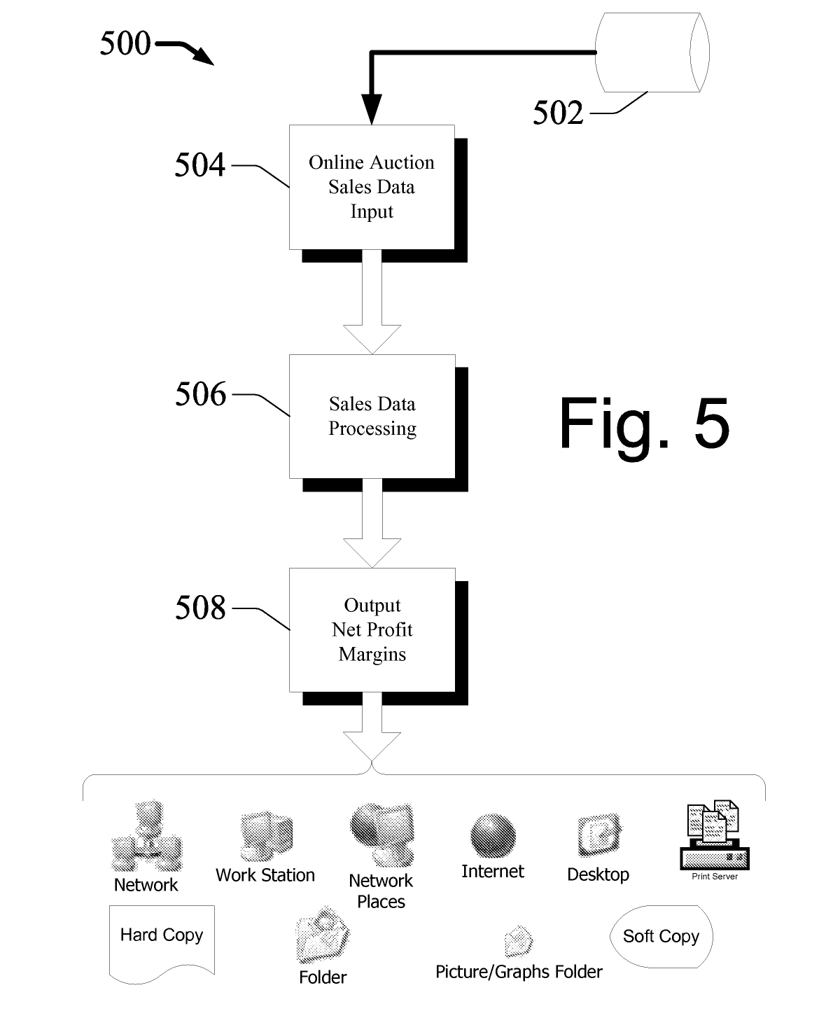

Referring to FIG. 5, an exemplary process 500 is presented as in flowchart format. A data storage 502 provides online auction sales data input 504 for analyzing profitability of an online auction business of a seller. The profitability is assessed by the processing of sales data 506. The result of the processing at step 506 is an output of net profit margins at step 508. As seen by the output from step 508, various icons demonstrate the versatility of formats, reports, and files containing the computed net profit margins that can be created for the seller's use and benefit. These include output data files, transmissions of data via network trafficking, soft and hard copies, etc.

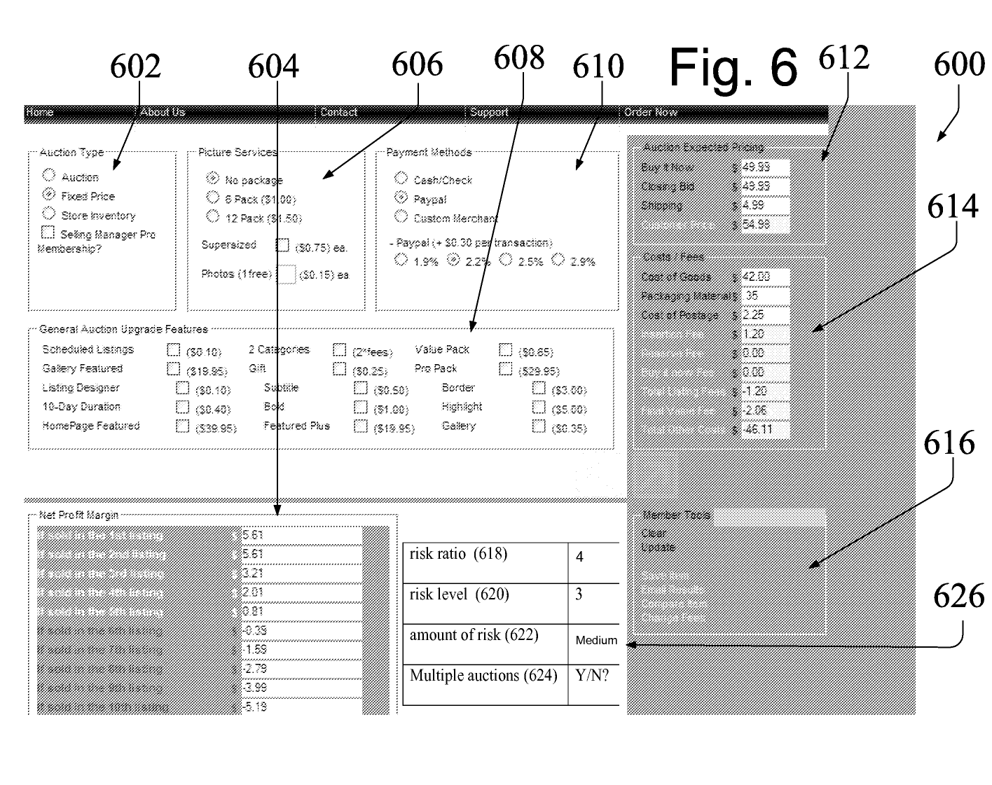

Referring to FIG. 6, an exemplary screen shot 600 presents an interactive user interface that can be used in the process 500 seen in FIG. 5. At reference numeral 602, various radio buttons are provided for the seller to specific an auction type. Field 602 allows the seller to specify if the seller wants to use an auction, fixed price or store inventory format to list their item for sale. Applicable fees are applied to the costs/fees section based on user input.

At reference numeral 606, various radio buttons are provided for the seller to specify picture services as to choices of the amount of pictures and services that the seller would like to add to the auction listing. Based on the seller's input, applicable fees for these services will be applied to the costs/fees section.

At reference numeral 610, various radio buttons are provided for the seller to specify payment methods. Field 610 allows the seller to choose a payment method that the seller will accept for the sale of the product. The seller can choose from cash/check, PayPal or a merchant account issued for a banking institution. The seller can specify the PayPal rate that the seller has negotiated that the seller will be charged (e.g.; based on the seller's monthly transaction volume). The seller and can also specify a custom rate for the terms agreed upon by the banking institution that issued the merchant account to the seller. Based on the seller's input, fees will be reflected in the costs/fees section.

At reference numeral 608, various check boxes are provided for the seller to specify general auction upgrade features. Field 608 allows a seller to choose which listing upgrades that the seller would like to add to their listing. They can choose to add a scheduled listing, list in 2 categories, value pack, gallery featured, gift, pro pack, listing designer, subtitle, border, 10-day duration, bold, highlight, home page featured, featured plus or gallery. Based on the seller's choices, fees for these features will be reflected in the costs/fees section.

At reference numeral 604, net profit margin is automatically calculated and output on screen 600 for the first 10 attempts to list the item for sale. The numbers at reference numeral 604 are calculated using figures input by the seller into the Auction Expected Pricing section 612 and the costs/fees section 614. The numbers at reference numeral 604 are also automatically reduced during subsequent attempts to list the item for sale, reflecting the loss of listing fees that the seller can no longer recover. The “If sold in the 2^{nd} listing” field is coded to automatically reflect the auctioneer's insertion fee credit policy. If the item does not sell during the 1^{st} listing, but sells during the second, the auctioneer refunds sellers for the insertion fee paid to list the item a second time.

At reference numeral 616, a member tools section allows the seller to save the calculations made for specific inventory items in a database 502 as seen in FIG. 5. The seller can access database 502 at any time when logged into the system. This enables the seller to return and view the calculations previously made on a specific item instead of entering the information all over again. This will benefit the seller by allowing the seller to re-visit their pricing and listing strategies on each individual item, and give them an organized way of monitoring how profitable their items are.

Reference numeral 626 in FIG. 6 is an output area of screen shot 600 that includes fields 618-624. At reference numeral 618, a risk ratio calculation is shown. The risk ratio takes the potential profit of selling the item during the first listing, and divides that profit by the listing fees that users are charged by the auctioneer for each time that the auctioneer runs the listing. Based on this ratio, a corresponding risk level will be assigned to show the seller how risky the item is. The interactive software tool will calculate this ratio for the seller, and from there calculate the corresponding risk level as well.

At reference numeral 620, a risk level calculation is shown. The risk level reveals on a scale of 1 to 5 how much risk the seller is taking on by attempting to sell the item using the sales price and listings features currently specified. As such, the tool alerts the seller to items that may be a too risky to offer in a fixed price or auction format, without a great deal of detailed analysis having to be done by the seller. Based on this number, the tool will assign an “amount of risk” to each level.

At reference numeral 622, an amount of risk calculation is shown. The amount of risk calculation is based on the risk level. Field 622 will reveal how risky the item is. The amounts of risk can be assessed as lowest, low, medium, high, and highest.

At reference numeral 624, a seller can specific multiple auctions. This will give the seller the ability to track profitability of multiple auctions of the same product, spread out over a period of time. This will show profit margins gained for each individual auction, all auctions of the same product collectively, and average profit margin per unit.

It is further intended that the tool will be effective with different kinds of items and rules applicable thereto, including land, air and sea vehicles, as well as real estate. Moreover, the tool will make calculations available in different currencies and be able to automatically calculate the “break-even” price that a seller will need to sell an item for at online auction to break-even on the sale. The tool can also link directly to sales data provided by an auctioneer to automatically show users the true profit margins achieved by the seller on every sale that is made at the auctioneer's online auction. The interactive software tool will track how many times the item was listed for sale before it sold, and use those figures to calculate the true profit margin of the sale using the standard calculations used in the “Net Profit Margin” section of the interactive software tool.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An interactive online auction listing profitability analysis software tool comprising:
means for receiving a plurality of options for listing an item offered for sale at an online auction, where the plurality of options are selected by a seller of the item; and
means, for each of the plurality of options, for rendering a quantified currency value at risk for listing the item at each of a plurality of prices at the online auction.

2. The interactive online auction listing profitability analysis software tool as defined in claim 1, further comprising means, if the listed item is not sold at each of a plurality of successive listing at the online auction, for rendering:
a profit margin; and
a currency value at risk.

3. A computer readable medium comprising instruction which, when executed by a computer, perform the steps of:
receiving, from a user interface, a plurality of options for listing an item offered for sale at an online auction;
deriving for each of a plurality of listing prices:
for each of the plurality of listing options:
a quantified currency value at risk for listing an item at the listing price using the listing option at the online auction.
and
rendering each said quantified currency value at risk for said listing of the item at each of the plurality of prices at each of the plurality of listing options at the online auction.

4. The computer readable medium as defined in claim 3, wherein the rendering step further comprises:
rendering fees charged by the online auction;
rendering fees charged by a purchaser of the listed item; and
rendering a fee charged for use of a debit or credit cad by the purchaser of the listed item.

5. The computer readable medium as defined in claim 3, wherein the rendering step further comprises rendering, if the listed item is not sold at each of a plurality of successive listing:
a profit margin; and
the currency value at risk.

6. A method comprising:
receiving from a user interface:
a plurality of options for listing an item offered for sale at an online auction; and
a plurality of listing prices for the item offered for sale at the online auction;
deriving for each of a plurality of listing prices:
for each of the plurality of listing options:
a quantified currency value at risk for listing an item at the listing price using the listing option at the online auction.
and
rendering for each of the plurality of prices:
for each of the plurality of listing options at the online auction:
listing fees charged by the online auction;
fees charged by a purchaser of the listed item;
fees charged for the use of a debit or credit card by the purchaser of the listed item; and
if the listed item is not sold at each of a plurality of successive listing:
a profit margin; and
a currency value at risk.
